(19) United States
(12) Patent Application Publication
(10) Pub. No.: US 2022/0177329 A1
(43) Pub. Date: Jun. 9, 2022

(54) Water Softener System

(71) Applicant: KYUNGDONG NAVIEN CO., LTD., Gyeonggi-do (KR)

(72) Inventors: Soo Young LEE, Seoul (KR); Bum Seup KIM, Seoul (KR); Ji Hyung YOON, Seoul (KR); So Min LEE, Seoul (KR)

(73) Assignee: KYUNGDONG NAVIEN CO., LTD., Gyeonggi-do (KR)

(21) Appl. No.: 17/536,959

(22) Filed: Nov. 29, 2021

(30) Foreign Application Priority Data
Dec. 9, 2020 (KR) 10-2020-0171509

(51) Int. Cl. C02F 1/00; C02F 1/469

(52) U.S. Cl. CPC C02F 1/008; C02F 1/4691; C02F 2209/10; C02F 2201/005; C02F 2209/44; C02F 2303/14; C02F 2209/40

(57) ABSTRACT

Disclosed is a water softening system including a first filter unit and a second filter unit that selectively performs a removal mode of discharging soft water that contains a smaller amount of an ionic material than source water or a recycling mode of discharging reclaimed water that contains a larger amount of the ionic material than the source water.

### CROSS-REFERENCE TO RELATED APPLICATION

This application claims the benefit of priority to Korean Patent Application No. 10-2020-0171509, filed in the Korean Intellectual Property Office on Dec. 9, 2020, the entire contents of which are incorporated herein by reference.

### TECHNICAL FIELD

The present disclosure relates to a water softening system.

### BACKGROUND

A water softening system is a system that produces soft water from source water and supplies the produced soft water to a source of demand. For example, in a water softening system of a points of entry (PoE) type, the source of demand may be a house, and the soft water delivered to a source of demand is in turn delivered to a water faucet, a shower head, and the like that require water.

A filter that softens source water by removing an ionic material from the source water cannot be used permanently, and even though it is a filter that may be used semi-permanently, it may be smoothly used only when a recycling operation of draining the collected ionic material is periodically performed.

A conventional electric deionization system that deionizes the source water by using an electric force has a limit in increasing recovery rate, and when an amount of the soft water is excessively increased to increase the recovery rate, the ionic material is not sufficiently removed from the source water, and thus the water softening performance is lowered. For example, the soft water of a low quality is discharged.

### SUMMARY

The present disclosure has been made to solve the above-mentioned problems occurring in the prior art while advantages achieved by the prior art are maintained intact.

An aspect of the present disclosure is directed to increase a recovery rate of a water softening system, and provides a water softening system that may drain reclaimed water in a burst scheme of repeatedly closing and opening drainage valves during recycling, and through this, may reduce an amount of discarded reclaimed water while sufficiently recycling the filter electrodes of the water softening system.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a water softening system includes a first filter unit and a second filter unit that selectively perform any one of a removal mode of discharging soft water that contains a smaller amount of an ionic material than source water or a recycling mode of discharging reclaimed water that contains a larger amount of the ionic material than the source water, a first discharge passage and a second discharge passage that discharges the soft water or the reclaimed water from the first filter unit and the second filter unit, respectively, a first drainage passage and a second drainage passage connected to the first discharge passage and the second discharge passage, respectively, and that drains the reclaimed water to an outside, a first drainage valve and a second drainage valve disposed in the first drainage passage and the second drainage passage, respectively, and that opens and closes the first drainage passage and the second drainage passage, respectively, and a controller that controls the first drainage valve or the second drainage valve to be repeatedly opened and closed during a recycling time period.

In an embodiment, the water softening system may further include a first supply passage and a second supply passage that supplies the source water to the first filter unit and the second filter unit, respectively.

In an embodiment, the controller may control such that at least a portion of the reclaimed water discharged from the second filter unit is supplied to the first filter unit when the first filter unit performs the removal mode and the second filter unit performs the recycling mode.

In an embodiment, the water softening system may further include a first discharge valve and a second discharge valve disposed in the first discharge passage and the second discharge passage, respectively, and that opens and closes the first discharge passage and the second discharge passage, respectively.

In an embodiment, the controller may control the first discharge valve to be opened, the second drainage valve to be repeatedly opened and closed, and the first drainage valve to be closed such that the reclaimed water to be drained to the outside during the recycling time period after the second filter unit starts the recycling mode.

In an embodiment, the controller may, during the recycling time period, controls the second drainage valve to be closed in a first time section, control the second drainage valve to be opened in a second time section that follows, control the second drainage valve to be closed in a third time section that follows, and control the second drainage valve to be opened in a fourth time section that follows.

In an embodiment, the first time section may correspond to a range of about 0% to 15% of the recycling time period, the second time section may correspond to a range of about 10% to 30% of the recycling time period, the third time section may correspond to a range of about 30% to 70% of the recycling time period, and the fourth time section may correspond to a range of about 5% to 15% of the recycling time period.

In an embodiment, the controller may control such that a time period obtained by adding the second time section and the fourth time section is 45% or more of the recycling time period during the recycling time period.

### BRIEF DESCRIPTION OF THE DRAWINGS

The above and other objects, features and advantages of the present disclosure will be more apparent from the following detailed description taken in conjunction with the accompanying drawings:

FIG. 1 is a conceptual view of a water softening system according to an embodiment of the present disclosure;

FIG. 2 is a block diagram of a water softening system according to an embodiment of the present disclosure;

FIG. 3 is a view illustrating a principle of removing an ionic material from a water softening system according to an embodiment of the present disclosure;

FIG. 4 is a view illustrating a principle of recycling electrodes in a water softening system according to an embodiment of the present disclosure;

FIG. 5 is a conceptual view illustrating a situation, in which soft water is provided and reclaimed water is drained by controlling filter units of a water softening system, which are disposed in parallel, according to an embodiment of the present disclosure;

FIG. 6 is a view illustrating a TDS according to drainage of reclaimed water in a water softening system according to an embodiment of the present disclosure; and

FIG. 7 is a conceptual view illustrating a situation, in which soft water is provided and reclaimed water is recovered by controlling filter units of a water softening system, which are disposed in parallel, according to an embodiment of the present disclosure.

### DETAILED DESCRIPTION

Hereinafter, some embodiments of the present disclosure will be described in detail with reference to the exemplary drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure rather unclear.

The terms, such as first, second, A, B, (a), (b) or the like may be used herein when describing components of the present disclosure. The terms are provided only to distinguish the components from other components, and the essences, sequences, orders, and the like of the components are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

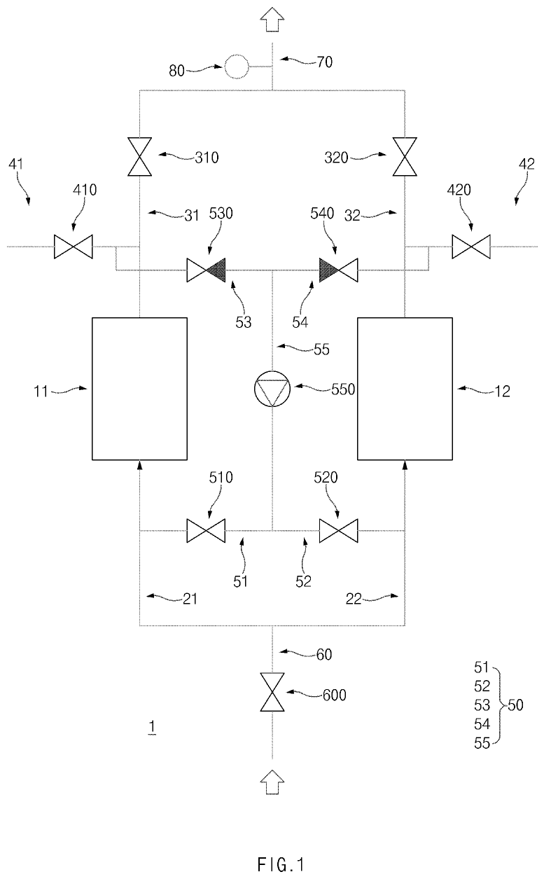

Hereinafter, embodiments of the present disclosure will be described in detail with reference to FIGS. 1 to 9.

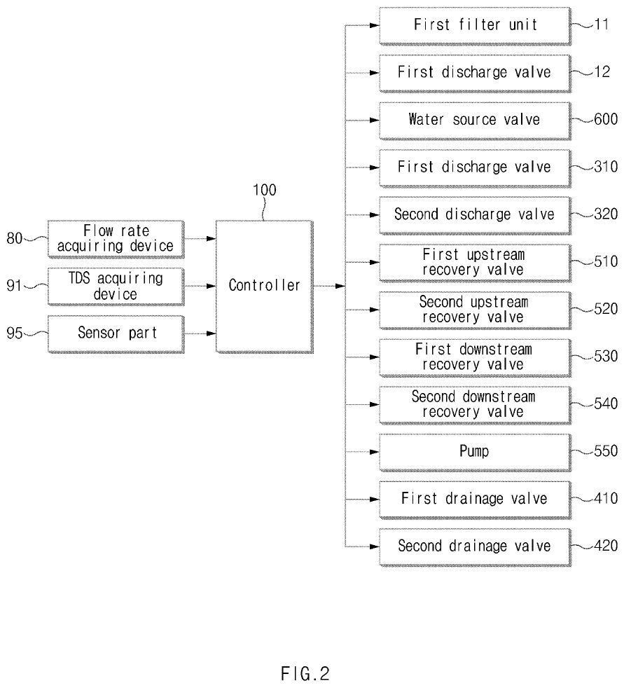

FIG. 1 is a conceptual view of a water softening system according to an embodiment of the present disclosure. FIG. 2 is a block diagram of a water softening system according to an embodiment of the present disclosure.

Referring to FIGS. 1 and 2, a water softening system 1 according to an embodiment of the present disclosure may include filter units 11 and 12, supply passages 21 and 22, discharge passages 31 and 32, a recovery passage part 50, discharge valves 310 and 320, drainage passages 41 and 42, drainage valves 410 and 420, a water source passage 60, a water source valve 600, a source-of-demand passage 70, a flow rate acquiring device 80, and a controller 100.

The supply passages 21 and 22 are passages configured to supply source water to the filter units 11 and 12, and a plurality of supply passages 21 and 22 may be arranged in parallel. Although it is illustrated in the embodiment of the present disclosure that a total of two supply passages 21 and 22 are formed and a first supply passage 21 and a second supply passage 22 are be disposed in parallel, configurations of the supply passages 21 and 22 are not limited thereto.

A water source and the filter units 11 and 12 may be connected to the supply passages 21 and 22, respectively. A first supply passage 21 may be connected to a first filter unit 11 and a second supply passage 22 may be connected to a second filter unit 12. Here, the meaning of “being connected” may include a case of “being directly connected” and a case of “being indirectly connected through another element”.

Accordingly, referring to FIG. 1, the water source and the supply passages 21 and 22 may be connected to each other in a scheme of connecting the supply passages 21 and 22 to the water source passage 60 connected to the water source and branching the supply passages 21 and 22. Interiors of the supply passages 21 and 22 may have shapes of a hollow tubular body such that the source water including at least one of water supplied from the water source and the reclaimed water is delivered to the filter units 11 and 12. A water source valve 600 may be formed in the water source passage 60 to determine opening/closing of the passage.

First and second upstream recovery passages 51 and 52 included in the recovery passage part 50, which will be described below, may be connected to the first and second supply passages 21 and 22, respectively. That is, the first supply passage 21 may be connected to the second recovery passage parts 54, 55, and 51 through the first upstream recovery passage 51, and the second supply passage 22 may be connected to the first recovery passage parts 53, 55, and 52 through the second upstream recovery passage 52.

The discharge passages 31 and 32 are passages that are configured to discharge the soft water or the reclaimed water from the filter units 11 and 12. Because two filter units 11 and 12 are provided, the number of the discharge passages 31 and 32 also may correspond to the number of the filter units 11 and 12 and the discharge passages 31 and 32 may be connected to the filter units 11 and 12, respectively. That is, the first discharge passage 31 may be connected to the first filter unit 11, and the second discharge passage 32 may be connected to the second filter unit 12.

Although it is illustrated in the embodiment of the present disclosure that a total of two discharge passages 31 and 32 are formed and the first discharge passage 31 and the second discharge passage 32 are be disposed in parallel, configurations of the discharge passages 31 and 32 are not limited thereto.

The discharge valves 310 and 320 are constituent elements disposed in the discharge passages 31 and 32, respectively, to adjust opening/closing of the discharge passages 31 and 32, and may open or close the discharge passages 31 and 32 as opening degrees thereof are adjusted.

When the discharge passages 31 and 32 are closed by the discharge valves 310 and 320, the water is not delivered to a source of demand through the closed discharge passages 31 and 32. When the discharge passages 31 and 32 are opened by the discharge valves 310 and 320, the water may be delivered to the source of demand through the opened discharge passages 31 and 32 or may be discharged or recovered to the filter units 11 and 12 through the drainage passages 41 and 42, which will be described below. The discharge passages 31 and 32 may have shapes of a hollow tubular body such that the water provided from the filter units 11 and 12 flows.

At least one of the discharge valves 310 and 320 may be controlled by the controller 100 (see FIG. 2) to be maintained in an opened state during an operation of the water softening system 1. Then, the discharge valve 310 or 320 that is maintained in the opened state may be the discharge valve 310 or 320 disposed in the discharge passage 31 or 32 connected to the filter unit 11 or 12 that performs a removal mode. For example, when the filter unit that performs the removal mode is the first filter unit 11, the first discharge valve 310 may be controlled to maintain an opened state.

Accordingly, even while any one of the filter units 11 or 12 performs the recycling mode, the soft water discharged from the filter unit 11 or 12 that performs the removal mode may be delivered to the source of demand.

Moreover, the source of demand and the discharge passages 31 and 32 may be connected to each other in a scheme of connecting the discharge passages 31 and 32 to the source-of-demand passage 70 connected to the source of demand and merging the discharging passages 31 and 32. The flow rate acquiring device 80, which will be described below, may be disposed in the source-of-demand passage 70.

The recovery passage part 50 is a constituent element for recovering and providing the reclaimed water discharged from the filter units 11 or 12 that perform the recycling mode to another filter unit 11 or 12. The recovery passage part 50 may include first recovery passage parts 53, 55, and 52 and second recovery passage parts 54, 55, and 51, and the first recovery passage parts 53, 55, and 52 and the second recovery passage parts 54, 55, and 51 may share a common recovery passage 55.

That is, the first recovery passage parts 53, 55, and 52 may include a first downstream recovery passage 53, a common recovery passage 55, and a second upstream recovery passage 52, and the second recovery passage parts 54, 55, and 51 may include a second downstream recovery passage 54, a common recovery passage 55, and a first upstream recovery passage 51.

The first recovery passage parts 53, 55, and 52 may be disposed to guide at least a portion of the reclaimed water in the first discharge passage 31 to the second supply passage 22, and the second recovery passage parts 54, 55, and 51 may be disposed to guide at least a portion of the reclaimed water in the second discharge passage 32 to the first supply passage 21. For the respective operations, the first recovery passage parts 53, 55, and 52 may be connected to the first discharge passage 31 and the second supply passage 22, and the second recovery passage parts 54, 55, and 51 may be connected to the second discharge passage 32 and the first supply passage 21.

The first upstream recovery passage 51 and the second upstream recovery passage 52 may be connected to the first supply passage 21 and the second supply passage 22, respectively. The first downstream recovery passage 53 and the second downstream recovery passage 54 may connect the common recovery passage 55 to the first discharge passage 31 and the second discharge passage 32, respectively. The reclaimed water introduced into the common recovery passage 55 from the discharge passage 31 and 32 through the downstream recovery passages 53 and 54, respectively, may be recovered in a scheme of delivering the reclaimed water to the supply passages 21 and 22 through the upstream recovery passages 51 and 52, respectively.

Various recovery valves may be disposed for opening and closing the recovery passage part 50. In detail, a first upstream recovery valve 510 and a second upstream recovery valve 520 may be disposed in the first upstream recovery passage 51 and the second upstream recovery passage 52, respectively. A first downstream recovery valve 530 and a second downstream recovery valve 540 may be disposed in the first downstream recovery passage 53 and the second downstream recovery passage 54, respectively. The first downstream recovery valve 530 and the second downstream recovery valve 540 may be check valves that allow only flows from the first discharge passage 31 or the second discharge passage 32 to the common recovery passage 55.

The reclaimed water may be prevented from being introduced into the filter units 11 and 12 again through outlet ends of the filter units 11 and 12 or being discharged to the source of demand through the discharge passages 31 and 32, by allowing only flows of the water from the first downstream recovery valve 530 and the second downstream recovery valve 540 to the common recovery passage 55 and, to the contrary, interrupting reverse flows of the water from the common recovery passage 55 to the discharge passages 31 and 32.

A pump 550 may be disposed in the recovery passage part 50 to pump the reclaimed water. The pump 550 may be a constant flow pump 550 that pumps the reclaimed water at a limit flow rate that is higher than a limit flow rate, at which the reclaimed water may be discharged through any one of the first and second drainage valves 410 and 420, which will be described below. A direction, in which the pump 550 pumps the water, may be a direction that faces the supply passages 21 and 22 from the discharge passages 31 and 32.

The filter units 11 and 12 may generate the soft water by removing the ionic material in the source water. The filter units 11 and 12 may be provided in the supply passages 21 and 22, respectively, and at least a portion of the ionic material contained in the supplied source water may be removed by an electric force so that the soft water that contains a smaller amount of the ionic material than the source water may be discharged, and the operation state may be defined as the removal mode.

The filter units 11 and 12 may discharge the ionic material collected during the operation together with the supplied source water so that the reclaimed water that contains a larger amount of the ionic material than the source water may be discharged, and the operation state may be defined as the recycling mode. The filter units 11 and 12 may selectively perform any one of the removal mode and the recycling mode. Although it has been described that the plurality of filter units 11 and 12 are provided and the two filter units 11 and 12 of the first and second filter units 11 and 12 are disposed, the configurations thereof are not limited thereto.

The filter units 11 and 12 may remove the ionic material in an electric deionization scheme. In the electric deionization scheme that is one of schemes of removing an ionic material, positive charge particles travel to a negative electrode and negative charge particles travel to a positive electrode when a DC voltage is applied to the charge particles in an electrolyte. That is, the electrical deionization scheme refers to a scheme of removing ionic materials in water by adsorbing or moving the ions (ionic material) through electrodes or an ion exchange membrane based on a principle of an electrical force (electrophoresis).

The electrical deionization scheme includes schemes, such as electrodialysis (ED), Electro deionization (EDI), continuous electro deionization (CEDI), and capacitive deionization (CDI) The ED type filter units 11 and 12 include electrodes and an ion exchange membrane, and the EDI type filter units 11 and 12 include electrodes, an ion exchange membrane, and an ion exchange resin. In contrast, the CD type filter units 11 and 12 include neither an ion exchange membrane nor an ion exchange resin, or do not include an ion exchange resin.

The filter units 11 and 12 according to the embodiment of the present disclosure may remove the ionic material in, among the electrical deionization schemes, the capacitive deionization (CDI) scheme.

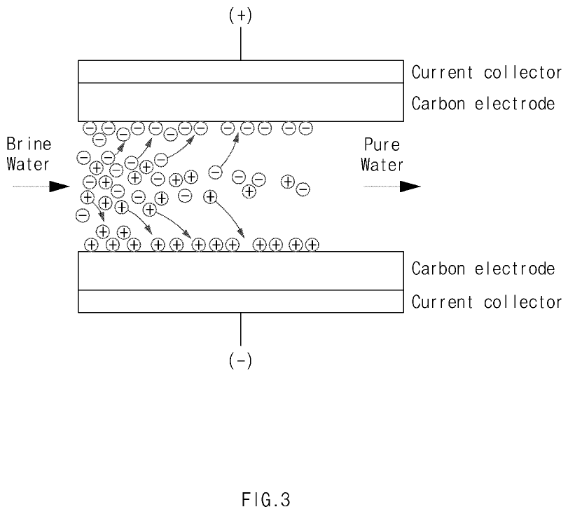

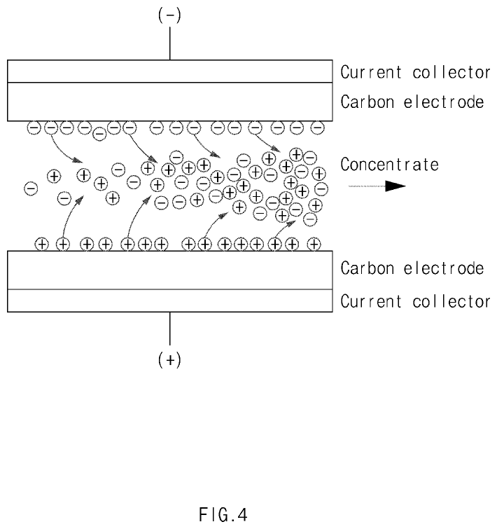

FIG. 3 is a view illustrating a principle of removing an ionic material from a water softening system according to an embodiment of the present disclosure. FIG. 4 is a view illustrating a principle of recycling electrodes in a water softening system according to an embodiment of the present disclosure.

Referring to FIGS. 3 and 4, the removal mode and the recycling mode of the CDI type will be described.

As illustrated in FIG. 3, in a state, in which a voltage is applied to electrodes, water containing ions passes between the electrodes, negative ions travel to a positive electrode, and positive ions travel to a negative electrode. That is, adsorption occurs, and ions in the water may be removed due to the adsorption.

In this way, a method of, by the filter units 11 and 12, removing an ionic material in the water that passes through the filter units 11 and 12 is called the removal mode.

Accordingly, adsorption capacities of the electrodes are limited, and adsorption continues, the electrodes reach a state, in which ions cannot be adsorbed any more. To prevent this, it is necessary to desorb the ions adsorbed to the electrode to recycle the electrodes.

To achieve this, as illustrated in FIG. 4, a voltage that is opposite to a voltage applied to the electrodes in the removal mode may be applied or a voltage may not be applied. In this way, a mode of recycling the electrodes by the filter units 11 and 12 is called the recycling mode. For example, the recycling mode may be performed before or after the removal mode.

For the operation, the filter units 11 and 12 may include electrodes, and may selectively perform any one of the removal mode of removing the ionic material in an electric deionization scheme through the electrodes and the recycling mode of recycling the electrodes.

Accordingly, when the source water is supplied to the filter units 11 and 12, at least a portion of the ionic material in the source water may be removed so that the soft water is generated and is discharged from the filter units 11 and 12 in the removal mode, and the ionic material in the electrodes may be provided to the source water so that the water having an increased content of the ionic material is discharged from the filter units 11 and 12 in the recycling mode.

The filter units 11 and 12, as descried above, may be connected to the supply passages 21 and 22 and the discharge passages 31 and 32 to receive the water through the supply passages 21 and 22 and discharge the treated water through the discharge passages 31 and 32. The source water containing at least one of the water delivered from the water source and the reclaimed water may be provided to the filter units 11 and 12, and the ionic material may be removed from the provided source water so that the soft water is generated and discharged, or the ionic material may be sent out so that the reclaimed water is generated and discharged.

The drainage passages 41 and 42 are constituent elements that are connected to the discharge passages 31 and 32 to drain the water in the water in the discharge passages 31 and 32. Accordingly, the drainage passages 41 and 42 may have a hollow tubular shape such that a fluid may flow therethrough. The drainage passages 41 and 42 may be disposed in the discharge passages 31 and 32, respectively.

Accordingly, in the embodiment of the present disclosure, because the discharge passages 31 and 32 include the first discharge passage 31 and the second discharge passage 32, the drainage passages 41 and 42 also may include the first drainage passage 41 and the second drainage passage 42, the first drainage passage 41 may be connected to the first discharge passage 31, and the second drainage passage 42 may be connected to the second discharge passage 32.

The water that passes through the filter units 11 and 12 may be discharged to the outside through the first and second drainage passages 41 and 42, and in particular, when any one of the filter units 11 and 12 is operated in the recycling mode, the reclaimed water discharged through the first discharge passage 31 or the second discharge passage 32 may be drained and discarded to the outside through the first drainage passage 41 or the second drainage passage 42. However, the reclaimed water is not always discharged, and whether the reclaimed water is discharged and an amount of the reclaimed water may be adjusted. Accordingly, the drainage valves 410 and 420 may be provided in the drainage passages 41 and 42 for opening and closing the drainage passages 41 and 42.

In the embodiment of the present disclosure, because the drainage passages 41 and 42 include the first drainage passage 41 and the second drainage passage 42, the first drainage valve 410 may be disposed in the first drainage passage 41 and the second drainage valve 420 may be disposed in the second drainage passage 42.

The drainage valves 410 and 420 may be constant flow rate valves that are configured to discharge the water at a specific flow rate.

The flow rate acquiring device 80 is a constituent element that acquires a flow rate of the water delivered to the source of demand, that is, a flow rate of the water used by a user. The flow rate acquiring device 80 is configured to acquire a total flow rate of the soft water discharged through the first discharge passage 31 and the second discharge passage 32. Accordingly, the flow rate acquiring device 80 may be disposed in the source-of-demand passage 70 to acquire a flow rate of the water that passes through the source of demand 70.

The flow rate acquiring device 80 may acquire the flow rate of the water delivered to the source of demand by using a Karman vortex scheme, a scheme using a Doppler effect, and the like, but the scheme of acquiring the flow rate is not limited thereto. The flow rate acquiring device 80 may be connected to the controller 100, and may deliver the acquired flow rate to the controller 100.

The controller 100 may adjust opening and closing of the valves according to the delivered flow rate, and may control an operation of the pump 550 based on the delivered flow rate, and may determine operation states of the filter units 11 and 12.

The controller 100 is a constituent element including an element that may perform logical operations for performing a control command, and may include a central processing unit (CPU). The controller 100 may be connected to the elements, such as the filter units 11 and 12, the discharge valves 310 and 320, and the like, to transmit signals according to the control commands to the element, and may be connected to the sensor parts 95 and the acquisition devices 80 and 91 to receive the acquired information in a form of signals.

Accordingly, in the embodiment of the present disclosure, the controller 100 may be electrically connected to the valves, the filter units 11 and 12, the flow rate acquiring device 80, and the pump 550 included in the water softening system 1. Because the controller 100 may be electrically connected to the elements, it may be connected to the elements by wire or may further include a communication module that may perform communication wirelessly for mutual communications.

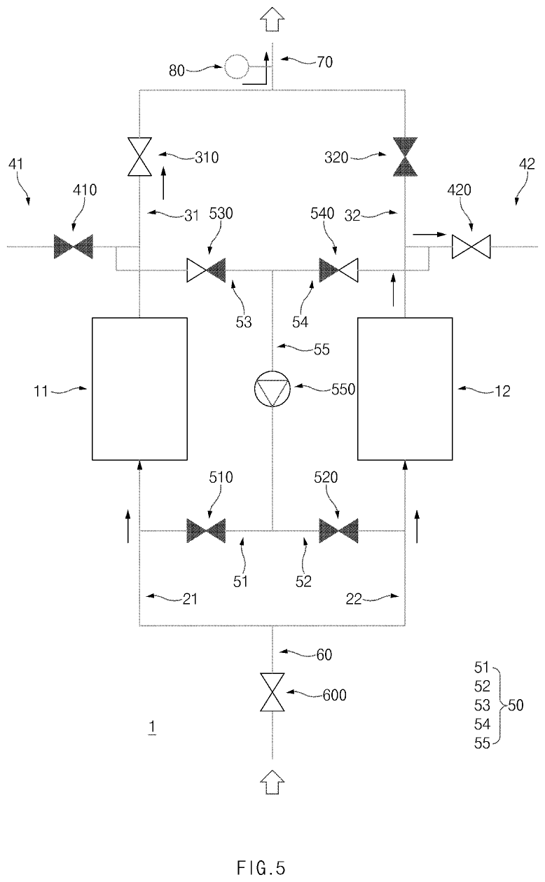

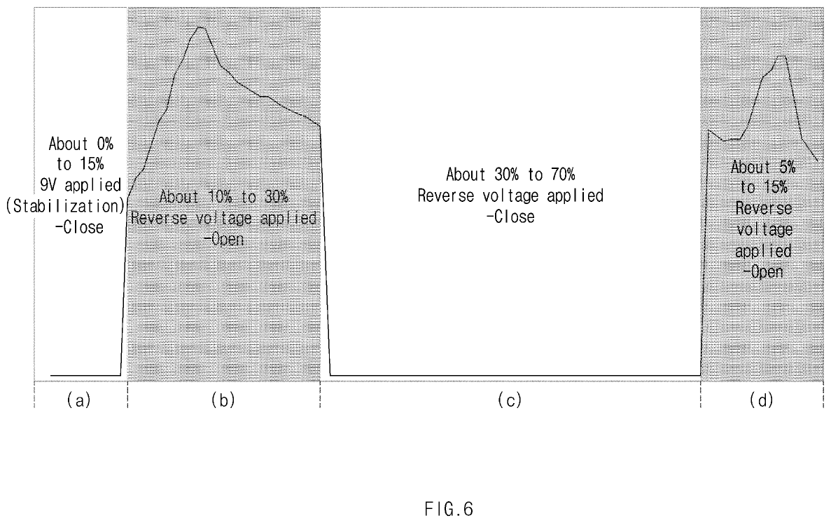

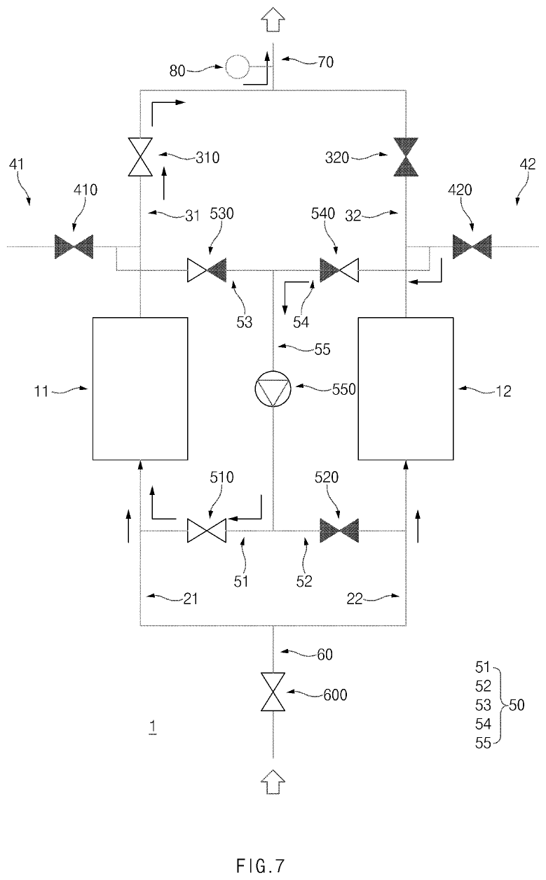

FIG. 5 is a conceptual view illustrating a situation, in which soft water is provided and reclaimed water is drained by controlling filter units of a water softening system, which are disposed in parallel, according to an embodiment of the present disclosure. FIG. 6 is a view illustrating a TDS according to drainage of reclaimed water in a water softening system according to an embodiment of the present disclosure. FIG. 7 is a conceptual view illustrating a situation, in which soft water is provided and reclaimed water is recovered by controlling filter units of a water softening system, which are disposed in parallel, according to an embodiment of the present disclosure.

A scheme of controlling the water softening system 1 by the controller 100 will be described with reference to FIGS. 5 to 7, and it will be assumed that the first filter unit 11 performs the removal mode and the second filter unit 12 performs the recycling mode.

However, this is for convenience of description, and the filter units 11 and 12 may be operated in a scheme of performing the recycling mode by the first filter unit 11 when the second filter unit 12 performs the removal mode, and then, the flows of the water and the operation states of the valves also may be changed in correspondence.

The controller 100 may control the reclaimed water to be drained though the second drainage passage 42 as in FIG. 5 during a specific period of time after the second filter unit 12 starts the recycling mode, and may control the reclaimed water to be supplied to the first supply passage 21 as in FIG. 7 until the recycling mode is ended after the specific period of time.

Because a larger amount of the ionic material included in the filter unit 11 and 12 is discharged together with the water at an initial stage, in which the filter units 11 and 12 are operated in the recycling mode, a total dissolved solid (TDS) of the reclaimed water is excessively high so that a quality of the soft water may be lowered when the reclaimed water is recovered and is used when the soft water is generated.

Accordingly, it is necessary to drain the initially generated reclaimed water rather than to recover it. Moreover, after a specific recycling time period after the filter units 11 and 12 start to be operated in the recycling mode, the TDS of the reclaimed water is sufficiently lowered, and thus it will be good even though the reclaimed water is recovered and is used when the soft water is generated. Accordingly, the discharge of the reclaimed water is stopped and the reclaimed water is recovered after the specific recycling time period, and thus recovery rate may be increased.

The specific recycling time period may be a period of time from a time point, at which the recycling mode is executed, to a time point, at which the TDS of the reclaimed water becomes less than three times of the TDS of the water provided from the water source.

Accordingly, the water softening system 1 of the present disclosure may further include a TDS acquiring unit (not illustrated) that may acquire TDSs of the discharge passages 31 and 32 and is further electrically connected to the controller 100, and the controller 100 may control the valves such that the water is discharged when the acquired TDS is not less than three times of the TDS of the water provided from the water source and is recovered when the acquired TDS is less than three times of the TDS of the water.

The controller 100 may control such that the first discharge valve 310 and the second drainage valve 420 are opened and the first and second upstream recovery valves 510 and 520 and the first drainage valve 410 are closed so that the reclaimed water is drained for a specific recycling time period after the second filter unit 12 starts the recycling mode.

Furthermore, the controller 100 may control such that the first discharge valve 310 and the first upstream recovery valve 510 are opened and the second discharge valve 320, the second upstream recovery valve 520, and the first and second drainage valves 410 and 420 are closed so that the reclaimed water is supplied to the first supply passage 21 through the second recovery passage parts 54, 55, and 51 after a specific recycling time period after the second filter unit 12 starts the recycling mode.

That is, the controller 100 may fully close the first and second upstream recovery valves 510 and 520 and open the second drainage valve 420 for drainage to prevent recovery in a stage, in which the recycling mode is started.

The controller 100 may control the second drainage valve 420 to be repeatedly opened and closed during the specific recycling time period when the reclaimed water is drained to the outside through the second drainage valve 420.

Referring to FIG. 6, the controller 100 may control the second drainage valve 420 to be closed while 0 V is applied to the electrodes of the second filter unit 12 in a first time section “a” that is a range of about 0% to 15% of the recycling time period during the recycling time period after the recycling mode is started.

Subsequently, the controller 100 may control the second drainage valve 420 to be opened while a reverse voltage is applied to the electrodes of the second filter unit 12 in a second time section “b” that is a range of about 10% to 30% of the recycling time period.

Subsequently, the controller 100 may control the second drainage valve 420 to be closed while the reverse voltage continues to be applied to the electrodes of the second filter unit 12 in a third time section “c” that is a range of about 30% to 70% of the recycling time period.

Subsequently, the controller 100 may control the second drainage valve 420 to be opened while the reverse voltage continues to be applied to the electrodes of the second filter unit 12 in a fourth time section “d” that is a range of about 5% to 15% of the recycling time period.

Then, the controller 100 may maintain a performance of the water softening system by controlling such that a time period obtained by adding the second time section “b” and the fourth time section “d” is 45% of the recycling time period or more, during the recycling time period after the recycling mode is started.

As described above, a hydraulic pressure of the second drainage passage 42 may be increased when the second drainage valve 420 is closed in the first time section “a”, and subsequently, a large amount of the ionic material may be drained together with the water of a relatively high hydraulic pressure when the second drainage valve 420 is opened in the second time section “b”.

Similarly, a hydraulic pressure of the second drainage passage 42 may be increased when the second drainage valve 420 is closed in the third time section “c”, and subsequently, a large amount of the ionic material may be drained together with the water of a relatively high hydraulic pressure when the second drainage valve 420 is opened in the fourth time section “d”.

Then, in the first time section “a”, a large amount of the ionic material is contained in the reclaimed water and thus the reclaimed water is not suitable for recovery due to a high TDS thereof, and in the second time section “b” and the fourth time section “d”, the reclaimed water is drained to the outside and thus it is impossible to recover the reclaimed water.

Meanwhile, because the ionic material is drained during the second time section “b” in the third time section “c”, the TDS is relatively low.

Accordingly, in the third time section “c”, the reclaimed water may be recovered and may be provided to the filter that is operated in the recycling mode together with the source water.

Accordingly, because the second drainage valve 420 is closed for a specific period of time, the amount of the water discarded to the outside may be reduced, and a relatively large amount of the ionic material may be discharged to the outside due to a high hydraulic pressure when the second drainage valve 420 is opened from the closed state for a specific period of time.

Furthermore, because flow velocity is instantaneously increased when the second drainage valve 420 is closed and then opened, the contaminants that may be formed in the second drainage valve 420 may be removed, and thus the second drainage valve 420 may be washed.

The controller 100 may control such that at least a portion of the reclaimed water discharged from the second filter unit 12 through the second discharge passage 32 is supplied to the first supply passage 21 through the second recovery passage parts 54, 55, and 51.

The soft water discharged from the first filter unit 11 may be discharged to the source of demand through the first discharge passage 31, and the reclaimed water discharged from the second filter unit 12 through the second discharge passage 32 may be delivered to the first filter unit 11 together with the water provided from the water source through the second recovery passage parts 54, 55, and 51 and the first supply passage 21.

Accordingly, because the first filter unit 11 receives the recovered reclaimed water together with the water provided from the water source and discharges the soft water by removing the ionic material, recovery rate may be increased.

To generate flows of water, the controller 100 may control such that the first discharge valve 310 and the first upstream recovery valve 510 are opened and the second discharge valve 320 and the second upstream recovery valve 520 are closed. Furthermore, the controller 100 may control such that the first drainage valve 410 and the second drainage valve 420 are closed so that the water is not drained.

Because the second discharge valve 320 and the second upstream recovery valve 520 are closed, the reclaimed water may be prevented from being delivered to the source of demand or from introduced into the second filter unit 12 again.

The controller 100 may control such that the pump 550 is operated when a flow rate of the source water acquired by the flow rate acquiring device 80 is higher than a specific threshold flow rate and is not operated when the flow rate of the soft water is not higher than the specific threshold flow rate. Here, the threshold flow rate may be higher than or the same as a limit flow rate of the pump 550 when the pump 550 is a constant flow pump 550.

When the pump 550 is to pump a flow rate of the soft water, which is higher than the flow rate of the soft water to be used by the user, the water is not immediately delivered to the first filter unit 11 that performs the removal mode but the entire water provided from the water source to the supply passages 21 and 22 is delivered to the second filter unit 12 to be delivered to the first filter unit 11 via the recovery passage part 50.

The above control may be performed by the controller 100 such that the recovered reclaimed water is mixed with the water provided from the water source at a proper ratio and is provided to the first filter unit 11 so that soft water of a good quality may be produced.

The controller 100 may control the pump 550 such that an amount of the reclaimed water provided to the first filter unit 11 becomes 30% to 40% of an amount of the soft water discharged from the first filter unit 11.

The drainage valves 410 and 420 may be constant flow valves having specific limit flow rates, and the pump 550 may be a constant flow pump 550 that pumps the water at a flow rate that is higher than the specific flow rates.

Accordingly, when the pump 550 is operated, in a general case, a flow rate of the water that passes through the second filter unit 12 may be higher than the flow rate of the water that passes through the second filter unit 12, and the TDS of the reclaimed water may be lowered such that the reclaimed water is recovered. Because the TDS of the recovered reclaimed water is lowered, the quality of the soft water generated through the first filter unit 11 may be increased while the recovery rate is increased.

As described above, the present disclosure is directed to increase a recovery rate of a water softening system, and may drain reclaimed water in a burst scheme of repeatedly closing and opening drainage valves during recycling, and through this, may reduce an amount of discarded reclaimed water while sufficiently recycling the filter electrodes of the water softening system.

The present disclosure is directed to increase a recovery rate of a water softening system, and may drain reclaimed water in a burst scheme of repeatedly closing and opening drainage valves during recycling, and through this, may reduce an amount of discarded reclaimed water while sufficiently recycling the filter electrodes of the water softening system.

In addition, the present disclosure may provide various effects that are directly or indirectly recognized.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

What is claimed is:

1. A water softening system comprising:
a first filter unit and a second filter unit configured to selectively perform any one of a removal mode of discharging soft water that contains a smaller amount of an ionic material than source water or a recycling mode of discharging reclaimed water that contains a larger amount of the ionic material than the source water;
a first discharge passage and a second discharge passage configured to discharge the soft water or the reclaimed water from the first filter unit and the second filter unit, respectively;
a first drainage passage and a second drainage passage connected to the first discharge passage and the second discharge passage, respectively, and configured to drain the reclaimed water to an outside;
a first drainage valve and a second drainage valve disposed in the first drainage passage and the second drainage passage, respectively, and configured to open and close the first drainage passage and the second drainage passage, respectively; and
a controller configured to control the first drainage valve or the second drainage valve to be repeatedly opened and closed during a recycling time period.

2. The water softening system of claim 1, further comprising:
a first supply passage and a second supply passage configured to supply the source water to the first filter unit and the second filter unit, respectively.

3. The water softening system of claim 1, wherein the controller controls such that at least a portion of the reclaimed water discharged from the second filter unit is supplied to the first filter unit when the first filter unit performs the removal mode and the second filter unit performs the recycling mode.

4. The water softening system of claim 1, further comprising:
a first discharge valve and a second discharge valve disposed in the first discharge passage and the second discharge passage, respectively, and configured to open and close the first discharge passage and the second discharge passage, respectively.

5. The water softening system of claim 4, wherein the controller controls the first discharge valve to be opened, the second drainage valve to be repeatedly opened and closed, and the first drainage valve to be closed such that the reclaimed water to be drained to the outside during the recycling time period after the second filter unit starts the recycling mode.

6. The water softening system of claim 1, wherein the controller, during the recycling time period, controls the second drainage valve to be closed in a first time section, controls the second drainage valve to be opened in a second time section that follows, controls the second drainage valve to be closed in a third time section that follows, and controls the second drainage valve to be opened in a fourth time section that follows.

7. The water softening system of claim 6, wherein the first time section corresponds to a range of about 0% to 15% of the recycling time period,
wherein the second time section corresponds to a range of about 10% to 30% of the recycling time period,
wherein the third time section corresponds to a range of about 30% to 70% of the recycling time period, and
wherein the fourth time section corresponds to a range of about 5% to 15% of the recycling time period.

8. The water softening system of claim 7, wherein the controller controls such that a time period obtained by adding the second time section and the fourth time section is 45% or more of the recycling time period during the recycling time period.
